(19) United States
(12) Patent Application Publication
(10) Pub. No.: US 2014/0280132 A1
(43) Pub. Date: Sep. 18, 2014

(54) METHOD AND SYSTEM FOR NETWORK ENABLED DIGITAL CLIPBOARD

(71) Applicant: DESIRE2LEARN INCORPORATED, Kitchener (CA)

(72) Inventors: Jeremy AUGER, Kitchener (CA); Brian CEPURAN, Kitchener (CA); John BAKER, Kitchener (CA)

(73) Assignee: DESIRE2LEARN INCORPORATED, Kitchener (CA)

(21) Appl. No.: 13/966,943

(22) Filed: Aug. 14, 2013

Related U.S. Application Data
(60) Provisional application No. 61/788,046, filed on Mar. 15, 2013.

(51) Int. Cl. G06F 17/30

(52) U.S. Cl. CPC G06F 17/30312
USPC 707/736

(57) ABSTRACT

A method and system for network enabled digital clipboard are provided. The method includes: performing a clipboard command with selected data at a first user device; retrieving metadata associated with the selected data at the first user device; storing the selected data and associated metadata at a network device; and performing a further clipboard command on the selected data and associated metadata at a second user device. The system having: a clipboard module at a first user device configured to receive a clipboard command for selected data, the clipboard module further configured to retrieve metadata associated with the selected data; a memory component at a network device configured for storing the selected data and associated metadata; a clipboard module at the network device for providing access to the selected data and metadata via a second user device; and a clipboard module at the second user device configured to access the selected data and metadata and perform actions on the accessed data.

### RELATED APPLICATIONS

This application claims priority to U.S. Provisional Patent Application No. 61/788,046 filed Mar. 15, 2013, which is incorporated herein by reference.

### FIELD

The present disclosure relates generally to a method and system for a digital clipboard. More particularly, the present disclosure relates to a method and system for a network enabled digital clipboard.

### BACKGROUND

Computer-based or “digital” clipboard functions are often used within a user-interface of a computer as a means for allowing the user to copy, cut, store and transfer/paste data, such as text, documents, cells, files, or the like, from a source to a destination. Clipboard functionality is present in many operating systems and software programs. Clipboard functionality typically includes the commands of cut, copy and paste.

According to the related art, the cut command operates by removing data selected by the user from its original position and placing that data on the digital clipboard. The copy command typically operates by creating a duplicate of data selected by the user and placing that data on the clipboard while leaving the original data in place. Finally, the paste command inserts data stored on the clipboard to a location/position selected by the user.

User-interfaces can provide clipboard functionality to the user through interactions such as key-combinations, pull-down menus, pop-up menus, or toolbar buttons. According to the related art, the contents of the clipboard are not presented to the user unless the user actively requests to view the clipboard's contents.

While clipboard functionality according to the related art is useful and used regularly, the present disclosure is directed at providing an improved method and system for a digital clipboard to provide enhanced functionality.

The above information is presented as background information only to assist with an understanding of the present disclosure. No determination has been made, and no assertion is made, as to whether any of the above might be applicable as prior art with regard to the present disclosure.

### SUMMARY

It is therefore desirable to mitigate at least one disadvantage of previous systems and methods for network enabled digital clipboards.

According to one aspect, there is provided a method for a network enabled clipboard, the method includes: performing a clipboard command with selected data at a first user device; retrieving metadata associated with the selected data at the first user device; storing the selected data and associated metadata at a network device; and performing a further clipboard command on the selected data and associated metadata at a second user device.

In some cases, the method may include editing the selected data prior to storing the selected data.

In some cases, the method may further include: selecting a plurality of stored selected data; and grouping the selected plurality of stored selected data.

In some cases, the first and second user devices are the same device.

In some cases, the method may further include: retrieving the selected data and associated contextual metadata; grouping the selected data and associated contextual metadata into desired fields; analyzing the data grouped into the desired fields; and reporting the analyzed data.

In some cases, the method may also include adding metadata to the metadata associated with the selected data. In some cases, the associated metadata includes tracking data related to the selected data. In a particular case, the associated metadata includes user data related to the selected data.

In another aspect, there is provided a system for providing a network enabled clipboard, the system having: a clipboard module at a first user device configured to receive a clipboard command for selected data, the clipboard module further configured to retrieve metadata associated with the selected data; a memory component at a network device configured for storing the selected data and associated metadata; a clipboard module at the network device for providing access to the selected data and metadata via a second user device; and a clipboard module at the second user device configured to access the selected data and metadata and perform actions on the accessed data.

In some cases, the clipboard module may further be configured to allow users to edit the selected data.

In some cases, the system may also include a grouping module configured to group a plurality of selected data into a single clipboard entry.

In some cases, the system may include a purge module configured to purge the stored selected data and associated contextual metadata.

In some cases, the associated contextual metadata may include tracking data related to the selected data. Similarly, the associated contextual metadata may include user data related to the selected data.

In yet another aspect, there is provided a system for providing a network enabled clipboard, the system having: a clipboard module configured to receive a clipboard command from a user, the clipboard command connected with selected data, the clipboard module further configured to retrieve contextual metadata associated with the selected data; a memory component configured for storing the selected data and associated contextual metadata; and a processing component configured to execute the clipboard command, the processing component further configured to report a source for the selected data.

In some cases, the processing component may be further configured to report the quantity of selected data retrieved by the user. In a particular case, the processing component may be configured to process the source of the selected data as an endnote or a footnote.

In some cases, the associated contextual metadata may be used to determine the copyright material selected by the user.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 is a schematic block diagram of a system for a network enabled digital clipboard, according to an embodiment;

FIG. 2 is an example of a clipboard layout, according to an embodiment;

FIG. 3 is an example of a browser window with a clipboard extension, according to an embodiment;

FIG. 4 is an example of a toolbox for a system for a network enabled clipboard, according to an embodiment;

FIG. 5 is a flow chart of a method for a cut command of a network enabled clipboard, according to an embodiment;

FIG. 6 is a flow chart of a method for a copy command of a network enabled clipboard, according to an embodiment;

FIG. 7 is a flow chart of a method for a paste command of a network enabled clipboard, according to an embodiment; and

FIG. 8 is a flow chart of a method for data mining with a system for a network enabled clipboard, according to an embodiment.

### DETAILED DESCRIPTION

Generally, the present disclosure provides example embodiments of a method and system for a network enabled digital clipboard. In particular, the example embodiments are intended to allow users to use clipboard functionality over a network and take advantage of data structures of network based applications. Clipboard functionality according to the related art is limited to operating systems and software programs on a user's local machine, and therefore, cannot generally take advantage of network based applications. The example embodiments herein are intended to further allow for metadata tracking for individual users or groups of users that may aid in monitoring the source of data/information. The monitoring is intended to assist with dealing with plagiarism issues in an educational environment and may provide users useful data for data mining operations but one of skill in the art will understand that this monitoring may be used in other fields as well.

FIG. 1 is a schematic block diagram of an embodiment of a system for a network enabled clipboard 100. The system 100 includes at least one user device 102 and at least one network device 104 connected via a network 106. The network 106 may be the Internet, a local area network (LAN), a wide area network (WAN), a personal area network (PAN), an enterprise network, a virtual private network (VPN), or the like.

The user device 102 is a computing device and may be, for example, a personal computer, personal digital assistant, smartphone, workstation, tablet, or the like. The user device 102 includes a processor 108 to process data, a memory component to store data, for example a database 110, a receiver 112 to receive data from the network 106, a transmitter 114 to transmit data over the network 106, an input component 116 to receive user input, for example, a keyboard, a touch screen, a mouse, or the like, and an output component 118 to output or display data, for example a screen, a monitor, or the like.

The network device 104 is a physically separate computing device dedicated to run one or more services for one or more user devices 102. The network device 104 may be a server or other centralized computing device in a network. The services may include, in addition to the clipboard functionality, web pages, domain name services, database and storage services, applications, e-mail, and the like. The network device 104 may be a stand-alone device or an arrangement of two or more devices working in conjunction with each other. The network device 104 includes a transmitting and receiving component 120, which is connected to the network 106 and may transmit data to and receive data from at least one user device 102 via the network 106. The transmitting and receiving component 120 may be a single component or, in some cases, the network device 104 may contain separate transmitting and receiving components. The network device 104 includes a clipboard module 122, at least one processor 146 for processing data and a memory component 124 for storing data, for example, a database. The processor 146 may be integrated with the clipboard module 122 or may be the processor for the network device 104 and be operatively connected to the clipboard module 122 in order to execute instructions received from the clipboard module 122. In some cases, each module of the clipboard module 122 may include at least one separate processor.

The memory component 124 includes a content storage component 126, which stores the contents of the selected data associated with the clipboard command. The content storage component 126 stores the selected data as a clipboard entry and is designed to store multiple entries as well as various data structures and data types. The data types may include an arrangement or collection of data in, for example, plain text, rich text, HyperText Markup Language (HTML) text, Extensible Markup Language (XML) text, data-tree, file, folder, object format, or the like.

The memory component 124 may also include a metadata component 128, which stores metadata related to the selected data such as, contextual information, for example, user, page context, path detail; content information, for example, reference file, tags, system information, or the like; and further metadata as described herein. The content storage component 126 and metadata component 128 may be separate databases or may be incorporated in a single database.

The clipboard module 122 may include various modules for receiving and storing instructions related to the clipboard commands. In one example, as shown, the clipboard module includes a cut module 130 for performing a cut command, a copy module 132 for performing a copy command, a paste module 134 for performing a paste command, a group module 136 for combining multiple clipboard entries together, a purge module 138 for removing entries from the content information component 126, a context module 140 for analyzing the metadata of clipboard entries, a selection module 142 for selecting information about selected data, and a display module 144 for displaying the contents of the clipboard, for example the selected data, the metadata, previously selected data and the like. In other cases, these various modules may be combined or grouped into fewer modules.

In operation, the user device 102 receives a clipboard command, such as a command to copy or cut, from a user via the input component 116. The clipboard command may include highlighting or otherwise selecting data such as text, image(s), file(s), spreadsheet data, objects, or the like. The processor 108 then receives the clipboard command, determines which data the user has selected and executes the clipboard command on the selected data. The processor may store the selected data in the database 110. The processor 108 sends the clipboard command and selected data to the transmitter 114. The transmitter 114 transmits the command and selected data over the network 106 to the network device 104.

The network device 104 receives instructions associated with the clipboard command and the selected data from the user device 102 via the network 106. The network device 104 is adapted to receive the instructions associated with the clipboard command and the selected data via the receiver/transmitter component 120 and execute the clipboard command via the clipboard module 122 and processor 146. The network device 104 is further adapted to transmit a response via the receiver/transmitter component 120 to the user device 102.

When the user device 102 receives the transmitted response to the clipboard command from the network device 104, the response is received via the receiver 112. The transmitted data is processed by the processor 108, may be stored in the memory component 110, and may be displayed to the user via the output component 118.

The context module 140 of the clipboard module 122 is configured to analyze metadata stored in metadata memory 128. Various types of metadata may be stored and analyzed depending of the data type of the selected data, the source of the selected data and the proposed data mining with respect to the selected data. For example, the metadata may include descriptive data about a related data set, object, or resource. The context module 140 may further ensure that a particular type of metadata is included based on the use of the system 100, that a particular type of metadata is stored by the memory component 124, or the like.

In some cases, the type of metadata examined by the context module 140 is tracking information related to the selected data. The tracking information may include a source location of the selected data, such as a website from which the selected data was copied or retrieved. The tracking information may also include a destination, such as a webpage in which the selected data is subsequently pasted. The tracking information may further include more specific contextual information regarding the source location and destination; for example, the form, frame, paragraph or section of the website. The tracking information may also include other content that surrounds or concerns the content data. The tracking information could also include information regarding the user's actions, for example, websites visited by the user, time spent on various websites, or other user actions. The user actions may include actions taken before the content data has been selected by the clipboard command, as well as actions after the content data has been copied, cut or pasted.

In some cases, the metadata examined by the context module 140 may also include mark-up information. The mark-up information could be the programming code or coding information that relates to the content data, for example, the HTML tags or C++ operators, or the like. The mark-up information may also be used to indicate attributes about the content data, for example, the format, arrangement, layout, configuration or the like. The mark-up information may also include a folksonomy or other types of custom data which correspond to the content data; for example, user-generated tagging, social tagging, taxonomy, indexing, annotation, bookmarking, or the like.

In some cases, the metadata examined by the context module 140 may be user data. The user data may include the time the clipboard command was initiated by the user, user identification information such as, the Internet Protocol address (IP address), Media Access Control address (MAC address), geographical information relating to the location of the user's device, a user classification such as administrator, instructor, student, employee, or other classification data. The user data may further include the behaviors, habits, or conduct of the user when using the user device 102.

Other metadata may be stored and the metadata may be associated with both the content data, stored in the content storage component 126, and associated with a specific user and user device. Having the metadata associated with the content data and the user data may aid in the data mining aspects provided by the clipboard module 122 and described below.

The context module 140 is adapted to review the associated metadata stored in the metadata component 128 and may produce data mining reports for the users of the system 100. In some cases, the context module may group users together using various user identification criteria and may produce a report showing metadata related to the group of users. In other cases, the context module 140 may produce reports related to the various pasted content in a document or other material produced by a single user of the system 100. In some cases, the context module 140 may allow the user to select which classification of user or specific users and what forms of metadata to include in a report.

The cut module 130 examines the content data from the source location and ensures that the content data is stored by the clipboard in the content storage component 126. Additionally, the cut module 130 may store metadata associated with the selected data or may reference this metadata stored in the metadata component 128. The cut module 130 may then remove or delete the corresponding selected data from the source location.

In some cases, where the cut module 130 does not have permission, access, or the ability to remove or delete the selected data, the cut module 130 will prompt the user with an error message. In other cases, where the cut module 130 does not have permission, access, or the ability to remove or delete the selected content, the cut module 130 will transmit the data and clipboard command to the copy module 132 and the copy module 132 will copy the content to the server 104 without removing the original data. In some cases, where the cut command was successful, the cut module 130 may be designed to prompt or notify the user that the selected data has been cut.

The copy module 132 examines the selected data from the source location and ensures the selected data is properly stored. Additionally, the copy module 132 may store metadata or may reference metadata stored in the metadata component 128 concerning the selected data. In some cases, the copy module 132 can prompt or notify the user that the selected data has been copied.

The group module 136 allows the user to merge two or more entries stored in the content storage component 126 into one entry. The group module 136 selects the clipboard entries to merge based on the selection of the user as retrieved from the display module 142. The group module 136 merges the selected data and may combine the associated metadata of the multiple entries by examining the attributes of the content to be merged and ensuring a cohesive order is maintained. In some case, the group module 136 may merge multiple entries by simply stacking the entries in an order chosen by the user, an order based on predetermined criteria or an order based on the associated metadata, for example, time the clipboard command was given, type of data, or the like.

The purge module 138 allows the user to remove one or more entries from the clipboard. The purge module 138 removes clipboard entries based on the selection of the user as retrieved from the selection module 142. If the entry has not been pasted the purge module 138 may delete the selected data and associated metadata, if the entry has been pasted, the purge module 138 may remove the entry from the display but the selected data and associated metadata may remain stored in the memory component 124 as the entry is associated with a destination. A second user may still wish to review the associated metadata when reviewing the data at the destination. The selected data and associated metadata may also still be used and retrieved in data mining operations.

The paste module 134 is configured to insert the selected data into the destination as determined by the user of the system 100. In some cases, the paste module 134 retrieves the selected data from the content storage component 126 and the metadata from the metadata component 128 for either an entry that was most recently entered into the memory components or a user selected entry. Then the paste module 134 inserts the selected data into a paste location that is selected by the user. The paste module 134 may ensure that the associated metadata continues to be associated with the selected data in the new location.

In some cases, the associated metadata is used to adjust properties of the selected data when the selected data is pasted, such as, the selected data's format, text, object, mark-up, tags, or the like. When adjusting the properties, the paste module 134 may use the context and properties of other content in the vicinity of the paste location. In other cases, the paste module 134 retrieves and stores metadata corresponding to, for example, the pasted data, paste location, and contextual content in the database 124. The metadata may include aspects such as where the selected data originated, where the selected data was pasted and other associated information, all of which may be stored in the database 124, and may be used for various tracking and data mining purposes. Additional metadata may be added to the pasted content, such as, context, source, classification, user data, or the like.

In some cases, the pasted data may be changed from one format to another when the data is pasted. For example, a clipboard entry that is a software file may be changed into a textual representation of that file when the entry is pasted into a text-only object. In some cases, the paste module 134 may prompt the user if the format of the selected data is required to change to be pasted to allow the user to determine if the change is acceptable. In other cases, the user may wish to change the format of the selected data and may request the format change, in which case the paste module 134 will make the required changes to the selected data to meet the user requirements.

The paste module 134 may select the clipboard entry to paste based on the selection of the user as retrieved from the selection module 142. In a further case, the paste module 134 allows the user to select multiple clipboard entries for pasting. The paste module 134 may insert the multiple entries as a series of entries, or the group module 136 may merge the entries into a single entry prior to the paste module 134 pasting the entries.

The display module 144 is adapted to display the contents of the clipboard to the user. The display module 144 may transmit the contents to the receiver/transmitter component 120 and the receiver/transmitter component 120 may transmit the contents and associated metadata to the user device 102. The output component 118 of the user device 102 will display the content to the user. In some cases, the user may select the metadata to be transmitted.

In some cases, it is intended that the example embodiments of the method herein are run via a supported web browser as an extension of the browser with little to no extra requirements on the user device 102. In some example embodiments, the method may be a component of the browser software, a component or extension to other types of software, a stand-alone software, or a component of the user's, router's or server's operating system.

FIG. 2 illustrates an example of a clipboard 200 as displayed on a user device 102 from data received from the display module 144. The clipboard 200 may display a similar display for each clipboard entry wherein the user is shown the selected data and at least some of the associated metadata. In this example, a first entry 220 displays the selected data, in this case, text, along with metadata consisting of the mark-up tags and contextual information. A second entry 222, also text, further includes metadata consisting of classification data. A third 224, fourth 226, and fifth 228 entries include non-textual content along with the associated metadata. Each entry may include a selection box 210. Additionally, there may be a select-all selection box 212. The selection boxes 210 and the select-all box 212 may be used by the user to signify which clipboard entries are to have actions performed on them. In this example, the user can select the actions of paste 230, group 232 or purge 234 in relation to the shown clipboard entries.

In other cases, the clipboard may only display the selected data and the user may drill down (e.g. click on or otherwise select) on the selected data to retrieve the associated metadata. In still other cases, the system 100 may provide a selection box or predetermined settings to allow the user to indicate which associated metadata the user would like displayed with each entry. In still other cases, default types of metadata may be displayed and the user may select further types or different types of associated metadata to be displayed.

In some cases, the system for network enabled clipboards may include a newly or recently added indicator to differentiate between a newly or more recently added item on the clipboard and items that have been added previously. In other cases, the time and date of the addition of the item may be displayed to the user. Including differentiators is intended to increase the user-friendly aspects of the system such that a user knows when each clipboard item was stored by the system.

FIG. 3 illustrates an example of a graphical user interface (GUI) 300 at the user device 102. In FIG. 3, a clipboard 302 is shown as a browser extension. In this example, the clipboard 302 is displayed in a portion of the browser 300 to the side of the webpage contents 304. The content sections of the webpage, including, for example, the title 310, sub header 312, side frames 314, and substantive contents 316, may be shifted and formatted to accommodate the clipboard 302 using some of the browser 300 space. In other cases, the title 310, sub header 312, side frames 314, and substantive contents 316 are not modified and the clipboard 302 is overlaid on top of the webpage contents 304. In other cases, the clipboard 302 may be in a new browser window. In still other cases, the clipboard may be hidden or displayed based on a user selection, for example the clipboard may be hidden off to the side and may appear if the user moves a cursor to that side of the screen or otherwise activates that area.

FIG. 4 is a graphical representation of a graphical user interface (GUI) 400 at the user device 102 showing a toolbox 404 that may be associated with a clipboard 402. The selection module 142 may be configured to produce the toolbox for the user to modify selected data or the associated metadata. The toolbox 404 may automatically appear when the user selects data for a clipboard command, or may be displayed on receipt of user input requesting the toolbox. The clipboard 402 shows the user the entries which have been previously been stored. The selection module 142 offers the user a set of tools available for the selected data. The toolbox 404 may be displayed to the user when the user selects data prior to the data being stored by the system 100 or may be displayed to the user when the user selects a specific entry from the clipboard 402. The toolbox 404 includes tools which may be based on various attributes and access rights of the selected data. The tools may include, for example, editing the name of the entry 410, editing the selected contents 412, and displaying the metadata such as mark-up tags 414 or classifications 416. In further embodiments, the tools may include, for example, clipboard commands, edit options, or metadata selection tools.

In some cases, the toolbox of the clipboard allows for editing. A user may be able to edit copied or cut text, files or objects through the toolbox prior to storing or pasting the selected data. Allowing the user to edit prior to storing or pasting may allow the user to make small or quick changes while maintaining the associated metadata such as the source location and other data that may be relevant to the selected data. The toolbox may further offer the user mark-up abilities. The user may include tags or specify the type or format of associated metadata the user would like associated with the selected data.

FIG. 5 is a flowchart of an embodiment of a method 500 for the cut command of a network enabled clipboard. At 510, the user device 102 receives the cut command from the user. The cut command is associated with user selected data from a source location. At 512, the user device 102 analyzes the selected data and associated metadata to ascertain the format of the selected data as well as the appropriate metadata to store. The appropriate metadata may be selected by the user via a toolbox similar to the toolbox shown in FIG. 4, or may be predetermined by the system 100 based on the format of the data and the intended data mining.

At 514, the user device 102 then sends the selected data and associated metadata to the network device 104. At 516, the network device 104 stores the selected data and metadata in the memory component 124. At 518, the network device 104 may send an acknowledgment signal to the user device 102 signifying that the selected data was successfully stored. At 520, the user device 102 may then determine whether the user device 102 has the proper permission to remove the selected data based on the permissions associated with the data. The user device 102 may determine the permissions prior to selecting the data or may determine the permissions while sending the data to the network device 104. If the user device 102 determines that the user does not have permission or lacks the ability to remove the selected content, the selected content is kept and remains unchanged at 522. The user device may prompt or notify the user that the user does not have the permissions to remove the selected data from the source location. If the user device 102 determines that it does have permission and the ability to remove the selected data, the selected data is removed from the source location at 524.

FIG. 6 illustrates an embodiment of a method 600 for the copy command of a network enabled clipboard according to an embodiment. At 610, the user device 102 receives the copy command from the user. At 612, the user device 102 analyzes both the selected data and associated metadata to ascertain the format of the selected data as well as what metadata is associated with the selected data. At 614, the user device 102 then sends the selected data and associated metadata to the network device 104. At 616, the network device 104 stores the selected data and metadata in the memory component 124. At 618, the network device 104 may send a signal to the user device 102 signifying that the information was successfully stored on the server. At 620, the user device may notify the user that the selected data has been copied through, for example, a pop-up notification, an audible indicator, an icon indicator, or the like.

FIG. 7 illustrates an embodiment of a method 700 for the paste command of a network enabled clipboard with reference to the example clipboard in FIG. 2. At 710, the user device 102 receives a clipboard command from the user. At 712, the user device 102 determines whether the user has checked off any of the selection boxes 210, or the select-all box 212 in the displayed clipboard 200. If the user has not checked off any boxes, then at 730, the network device 104 retrieves the most recently entered clipboard entry from the server memory component 124. At 732, the user device 102 analyzes the context of where the user selected the data to be pasted by examining neighboring and related content and metadata.

At 734, the network device 104 uses this contextual information to adjust the properties and characteristics of the clipboard entry to complement and fit within the context of where the selected data is to be pasted. At 736, the network device 104 sends the selected data and metadata of the clipboard entry to the user device 102. At 738, the user device 102 then inserts the clipboard entry at the selected location. In some cases, the network device 104 may insert the entry as the destination of the selected data may not reside locally on the user device 102. In still other cases, the network device may send the entry to another user device or another network device to paste the entry as the destination resides on another network enabled computing device.

At 740, the user device 102 sends metadata about the pasting of the entry to the network device 104 where the network device 104 then stores the information in the memory component 124. Metadata about the pasting of the entry may include, for example, the time and date the entry was pasted, the location or destination the entry was pasted, information about the user, or the like. In some cases, the destination may be on another computing device and that other computing device communicates the metadata to the network device 104.

If the user has checked at least one selection box, then, at 714, the user device 102 will determine if one or multiple selection boxes have been checked, or if the select all box has been checked. If only one selection box 210 has been checked, then, at 720, the network device 104 will retrieve the selected clipboard entry from the memory component. Then the system will continue with the pasting command as above.

If multiple boxes have been selected, then, at 716, the server 104 will analyze the attributes of the multiple entries, including the data types of the selected entries and the associated metadata to each entry. At 718, the network device 104 may then use the attributes to merge the multiple entries into one. The network device 104 may merge the entries by choosing a cohesive order or may merge the entries in an order chosen by the user. Then the system will continue with the pasting command as above.

In some cases, if multiple boxes have been selected, the system may paste the entries chronologically or based on format type and may not merge the selected entries prior to pasting.

In some cases, the paste module will paste some or all of the associated metadata in-line with the pasted data. In other cases, the paste module may paste the metadata as an object, which the user or reader of the content may select to review the associated metadata. In still other cases, the pasted object may be a link or associated with a link and the user or reader may select the link which directs the user or reader to a separate location, for example a new browser page, to review of the associated metadata. In still other cases, the metadata may be presented as a combination of the above options. Allowing for various methods of pasting the associated metadata is intended to allow for greater flexibility in the system. If the stored metadata associated with the selected data includes several types of metadata, a combination of methods to display the metadata may be preferred. If the stored metadata includes, for example, only the source and author of the selected data, the user may prefer to display the metadata in-line with the selected data.

In some cases, the paste command may allow the user to paste to multiple locations with a single paste command. Once the user selects the paste command, the paste module may prompt the user if there are further destination locations in which the user would like to paste the selected data. The user may enter multiple destination locations for the selected data. Once the locations have been confirmed, the paste module may paste the selected data in the multiple destinations and may associate the metadata to the various locations. Further the system may store metadata related to the various destination locations where the selected data was pasted.

In some cases, embodiments of the system and method for the network enabled clipboard allow for the clipboard command to be performed on a generic object. The generic object may be a plug-in or another format that may not be supported in a conventional clipboard program. The system for network enabled clipboard may allow the user to perform a clipboard command on the object and may further store associated metadata with the generic object. Once the object is pasted, it is intended that the object function as the original. Storing the associated metadata will provide the system with further information which is intended to ensure that the function of the object will be the same as the original object.

FIG. 8 illustrates a method of data mining 800 using the system 100. At 802, a user interface will be displayed to a user with a data mining permissions in the system 100 in which the user interface asks the user for desired fields for review. Once the fields are selected, at 804 the context module 140 retrieves the metadata corresponding to the user's desired fields. The user may wish to group together a certain classification of users, or a group of destination locations, or other fields of metadata stored by the system in order to show aggregate data. At 806, the system 100 may then group the metadata into a more succinct report. For example, if a classification of users is selected, the system may determine the number of clipboard commands, the data associated with the clipboard commands and the time of the clipboard commands for each user in the classification of users. At 808, the grouped metadata may then be displayed 808 to the user as a report or in another user requested format.

In a specific example, a contributor for a website may receive data as to whom and how often content of the website is copied. This information may be beneficial to the contributor to allow the contributor to understand which parts of the content visitors to of the website consider worthwhile to copy.

The associated metadata may further include tracking data. The tracking data may include user tracking data, path of the user or a combination of the two. For example, the metadata may include the length of time the user was at the source location, how long from opening the browser or application prior to initiating the clipboard command, what websites or web pages were visited immediately prior to the source location, or the path from opening the browser or application to the source location. This tracking data may aid in data mining by determining how users reach the source destination and allow users to determine if there are ways to streamline the process. In a specific example, if it is noted that a portion of users coming from an originating page spend only a few seconds on one page before linking to a second page where these users then select to copy data, the metadata may suggest that the first page is only being used as a link and a link from the originating page to the second page may be beneficial. The associated metadata may provide further insight that may allow administrators or authors of websites or web pages to present more user-friendly sites.

In another example, storing and including the associated metadata with the pasted data may also be beneficial in an educational environment. For example, when an instructor receives assignments, or other material from the students, the assignments may be received electronically with the associated metadata. Not only may the assignments include automatic footnotes or endnotes using the metadata but also the instructor will be informed as to which material had been copied and pasted.

In some cases, embodiments herein may be used in a learning management system, for example, a system for the administration, documentation, tracking, reporting and delivery of education courses or training programs. When incorporated with a learning management system, the system 100 may have a plurality of associated metadata that are available or required when selected data is copied or cut by a student user. This required metadata may be configured to be locked such that a user may not edit the metadata and may not have the option to view this metadata when the data is selected. The required metadata may only be viewable by an administrator or instructor of the system, such that an administrator or instructor can review the required metadata to determine aspects related to material that has been pasted into any assignment or material from the student user of the learning management system. In some cases, the source location, the source author, the student user identification, the path to retrieve the selected data, and the like may be required metadata. This required metadata is intended to allow the administrator and instructor to determine not only the quality of the source data but also the quantity of material copied by the user of the learning management system.

The metadata may further provide the instructor with details as to how much of the assignment was sourced from a single or multiple locations. The instructor may have an easier time determining if the assignment has been copied or if the work is an original work of the student. The system 100 may aid in reviewing assignments and other material for plagiarism which is intended to improve the quality of students' works as the stored metadata associated with the material from the clipboard provides information as to what was reproduced and from where the material was sourced.

The embodiments herein are intended to provide a further benefit in that the clipboard data may be stored and retrieved by a user, even after the user has logged off or ended the connection with the system for a period of time. As the selected data is stored on a network device, the user may access the data at a later time, even after being logged off the system. This aspect is intended to provide a benefit to the user as, if the user accidently exits the system, or experiences computer or network issues that require him to log out of the system, data saved by the memory component of the system may be accessed by the user such that the user may retrieve the selected data and associated metadata after logging back into the system or re-establishing the network connection with the system.

It will be understood that some elements of the system and method may be provided/performed at either the user device or the network device as appropriate depending on the embodiment. As such, the system may be distributed between the user device and the network device in various ways while maintaining similar functionality.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A method for a network enabled clipboard comprising:
performing a clipboard command with selected data at a first user device;
retrieving metadata associated with the selected data at the first user device;
storing the selected data and associated metadata at a network device; and
performing a further clipboard command on the selected data and associated metadata at a second user device.

2. The method of claim 1 further comprising:
editing the selected data prior to storing the selected data.

3. The method of claim 1 further comprising:
selecting a plurality of stored selected data; and
grouping the selected plurality of stored selected data.

4. The method of claim 1 wherein the first and second user devices are the same device.

5. The method of claim 1 further comprising:
retrieving the selected data and associated contextual metadata;
grouping the selected data and associated contextual metadata into desired fields;
analyzing the data grouped into the desired fields; and
reporting the analyzed data.

6. The method of claim 1 further comprising adding metadata to the metadata associated with the selected data.

7. The method of claim 1 wherein the associated metadata includes tracking data related to the selected data.

8. The method of claim 1 wherein the associated metadata includes user data related to the selected data.

9. A system for providing a network enabled clipboard comprising:
a clipboard module at a first user device configured to receive a clipboard command for selected data, the clipboard module further configured to retrieve metadata associated with the selected data;
a memory component at a network device configured for storing the selected data and associated metadata;
a clipboard module at the network device for providing access to the selected data and metadata via a second user device; and
a clipboard module at the second user device configured to access the selected data and metadata and perform actions on the accessed data.

10. The system of claim 9 wherein the clipboard module is further configured to allow users to edit the selected data.

11. The system of claim 9 further comprising a grouping module configured to group a plurality of selected data into a single clipboard entry.

12. The system of claim 9 further comprising a purge module configured to purge the stored selected data and associated contextual metadata.

13. The system of claim 9 wherein the associated contextual metadata includes tracking data related to the selected data.

14. The system of claim 9 wherein the associated contextual metadata includes user data related to the selected data.

15. A system for providing a network enabled clipboard, the system comprising:
a clipboard module configured to receive a clipboard command from a user, the clipboard command connected with selected data, the clipboard module further configured to retrieve contextual metadata associated with the selected data;
a memory component configured for storing the selected data and associated contextual metadata; and
a processing component configured to execute the clipboard command, the processing component further configured to report a source for the selected data.

16. The system of claim 15 wherein the processing component is further configured to report the quantity of selected data retrieved by the user.

17. The system of claim 15 wherein the processing component is configured to process the source of the selected data as an endnote or a footnote.

18. The system of claim 15 wherein the associated contextual metadata is used to determine the copyright material selected by the user.

19. The system of claim 15 wherein the associated contextual metadata includes tracking data related to the selected data.

20. The system of claim 15 wherein the associated contextual metadata includes user data related to the selected data.

21. A non-transitory computer readable medium containing instructions that, when executed, perform the method of claim 1.
